(19) United States
(12) Patent Application Publication
(10) Pub. No.: US 2017/0313510 A1
(43) Pub. Date: Nov. 2, 2017

(54) ANIMAL RESISTANT DUMPSTER

(71) Applicant: Arlan Peckham, Hayden, CO (US)

(72) Inventor: Arlan Peckham, Hayden, CO (US)

(21) Appl. No.: 15/485,940

(22) Filed: Apr. 12, 2017

Related U.S. Application Data
(60) Provisional application No. 62/330,118, filed on Apr. 30, 2016.

(51) Int. Cl. B65F 1/16; B65F 1/02

(52) U.S. Cl. CPC B65F 1/1615; B65F 1/02; B65F 2210/148

(57) ABSTRACT

An animal resistant dumpster is described. Embodiments of the animal resistant dumpster include a lid rotatably coupled to a refuse container. The lid can be locked in a closed position by a pair of rotatable hooks. To open the lid, and empty the refuse container, the rotatable hooks can be disengaged by rotating the dumpster past parallel allowing the hooks to rotate due to gravity. The lid can include a pair of slidable doors to dispose of refuse into the refuse container.

### CROSS-REFERENCE TO RELATED APPLICATION

This application claims the benefit of U.S. Provisional Application No. 62/330,118, filed Apr. 30, 2016.

### BACKGROUND

Currently, commercial dumpsters are susceptible to being scavenged by animals and illegally accessed by people who are not authorized to use the dumpsters. As can be appreciated, the problem is food and refuse in dumpsters are strong attractants to animals. Bears, raccoons, coyotes, foxes, birds, and many other kinds of animals are attracted to the smell of fermenting food waste. Furthermore, once an animal accesses a dumpster, the animal is likely to return. Once an animal accesses a dumpster and continually returns, there is an increased probability of an animal-human encounter.

The attraction of bears is problematic in populated areas. The size and strength of a bear are potential threats to people and property. Further, animals entering populated areas are a threat to themselves as they can be injured or killed by automobiles, electric lines, and other human technologies. Thus, it is desirable to inhibit animals from access to any refuse dumpster.

There are many systems currently used to deter and keep animals from accessing a dumpster. A variety of latches, doors, and lids are available. Typically, lids and doors are heavy to lift to keep bears out, but cause system breaks in time due to repetition of dumping due to the heaviness of the lids. None of the currently available deterrents are very people friendly. Further, most currently available systems are not designed with refuse collectors in mind. As such, more work and time is needed to empty the dumpsters by refuse collectors.

As such, a system for deterring and keeping animals out of a commercial refuse dumpster, but is also people friendly and refuse collector friendly, is needed.

### BRIEF DESCRIPTION OF THE DRAWINGS

FIG. 1 is a front view of an animal resistant dumpster according to one embodiment of the present invention.

FIG. 2 is a top perspective view of an animal resistant dumpster according to one embodiment of the present invention.

FIG. 3 is a top perspective view of a first sliding door of an animal resistant dumpster according to one embodiment of the present invention.

FIG. 4 is a top view of a second sliding door of an animal resistant dumpster according to one embodiment of the present invention

FIG. 5 is a back view of an attachment rod apparatus of an animal resistant dumpster according to one embodiment of the present invention.

FIG. 6 is a back view of a frame of an animal resistant dumpster according to one embodiment of the present invention.

FIG. 7 is a back view of a commercial dumpster coupled to an animal resistant dumpster according to one embodiment of the present invention.

FIG. 8 is a side view of a locking mechanism of an animal resistant dumpster according to one embodiment of the present invention.

FIG. 9 is a side view of a gravity latch of an animal resistant dumpster according to one embodiment of the present invention.

### DETAILED DESCRIPTION

Embodiments of the present invention include an animal resistant dumpster, a kit for forming an animal resistant dumpster, and method(s) of use of the animal resistant dumpster. The animal resistant dumpster can be implemented to keep animals from getting into a refuse container while providing refuse collectors easy disposal of refuse inside the refuse container. Typically, after the kit has been coupled to a refuse container, the refuse container can be emptied by a refuse collector in a manner substantially similar to how the refuse container was previously emptied. For instance, the refuse container can be picked up by a refuse collecting truck to be emptied into the refuse collecting truck. Typically, when the refuse collecting truck starts to rotate the refuse container, gravity locks on the animal resistant dumpster can unlock and the refuse can be dumped into the refuse collecting truck.

Embodiments of the present invention can be implemented to stop bears and all other animals from entering a commercial dumpster. The animal resistant dumpster can include a pair of sliding doors that are easy to open for access, which makes the dumpster easy for people to use. Further, a locking mechanism can be implemented to lock the sliding doors in a closed position. As can be appreciated, the animal resistant dumpster can be easy to lock to keep animals out and also eliminate unauthorized people to access the refuse dumpster. As can be appreciated, the animal resistant dumpster kit can be attached or fitted to most, if not all, currently available commercial dumpsters. Typically, components of the animal resistant dumpster can be manufactured from rigid materials including, but not limited to, metals, plastics, etc. As can be appreciated, depending on the materials implemented, differing means of coupling components are contemplated including, but not limited to, welding, using adhesives, etc. The animal resistant dumpster can work for all parties involved including, but not limited to, drivers, customers, and to keep all animals from feeding on refuse. When locked, the animal resistant dumpster can inhibit access to refuse in a commercial dumpster by animals and can also help prevent people from illegally accessing the commercial dumpster.

One embodiment of the animal resistant dumpster kit can include, but is not limited to, a frame, a pair of sliding doors, a mounting apparatus, and a pair of gravity latches. The pair of sliding doors can both be designed to slide easily open to throw refuse away and easily close, no lifting of the frame is needed by people. The mounting system can be implemented to couple the frame to a commercial dumpster. In one instance, the mounting system can rotatably couple the frame to the commercial dumpster. Typically, the mounting system can be located on a bottom rear part of the frame to allow the sliding doors to go past the mounting system. In some embodiments, a latching apparatus can be implemented to hold and lock the sliding doors in a closed position. The pair of gravity latches can be implemented to keep the frame from being opened. Typically, a first gravity latch can be on the left of the frame and a second gravity latch can be on the right side of the frame. The gravity latches are designed to rotate and disengage from a receptacle when the dumpster is tilted by a commercial truck as the commercial truck is emptying the dumpster. As can be appreciated, to rotate the frame open and access the dumpster, both of the gravity latches would need to be disengaged.

An objective of embodiments of the present invention is to prevent animals from getting to refuse in a dumpster and to keep unauthorized people from using the dumpster, while making emptying of the dumpster easy for the commercial refuse industry. Embodiments of the present invention are intended to make maintaining, emptying, and providing commercial dumpsters easier for the commercial refuse industry.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of an Animal Resistant Dumpster

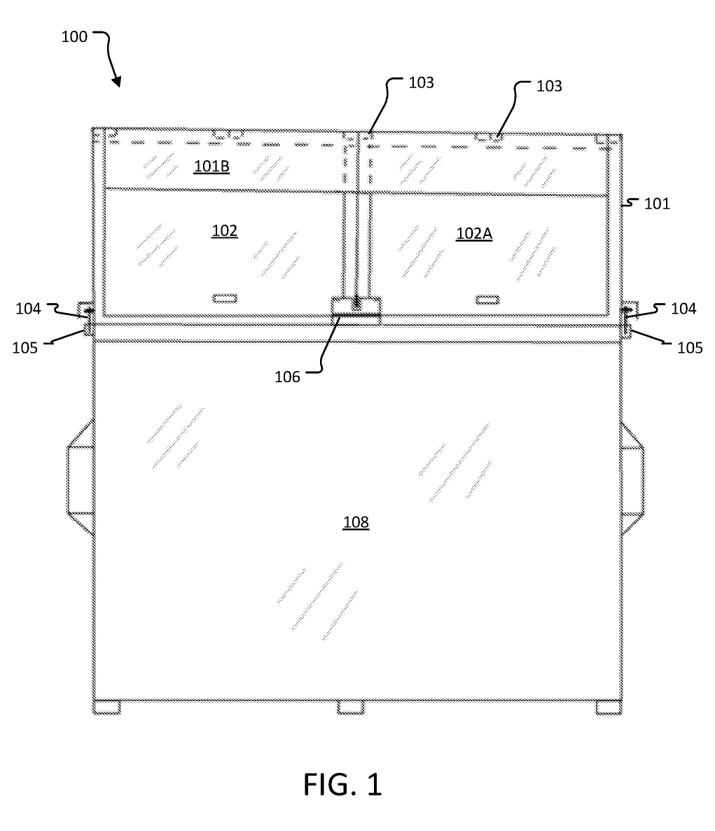

Referring to FIG. 1, a front view of an embodiment 100 showing an animal resistant dumpster is illustrated. In one embodiment, the animal resistant dumpster 100 can be assembled from a previously constructed refuse container and a kit including components for retrofitting the refuse container.

Typically, the animal resistant dumpster 100 can include a frame 101 rotatably coupled to a commercial dumpster (or refuse container) 108. The frame 101 can include, but is not limited to, a first cover sheet 101B, a first sliding door 102, a second sliding door 102A, a first set of knuckles 103, a pair of gravity hooks 104, and a locking mechanism 106. In one embodiment, the commercial dumpster 108 can be retrofitted with a second set of knuckles 103A (shown in FIG. 7) and a pair of receptacles 105 for engaging with the pair of gravity hooks 104. In another embodiment, the commercial dumpster 108 can be manufactured with the second set of knuckles 103A and the pair of receptacles 105.

Typically, the first sliding door 102 and the second sliding door 102A can be located inside the frame 101 and configured to slide up and down within the frame 101. As shown in FIG. 1, the locking mechanism 106 can be located in near a bottom of and in a middle of the frame 101. The pair of gravity hooks 104 are shown on a left side and a right side of the frame 101 and interacting with the pair of receptacles 105 on the dumpster 108.

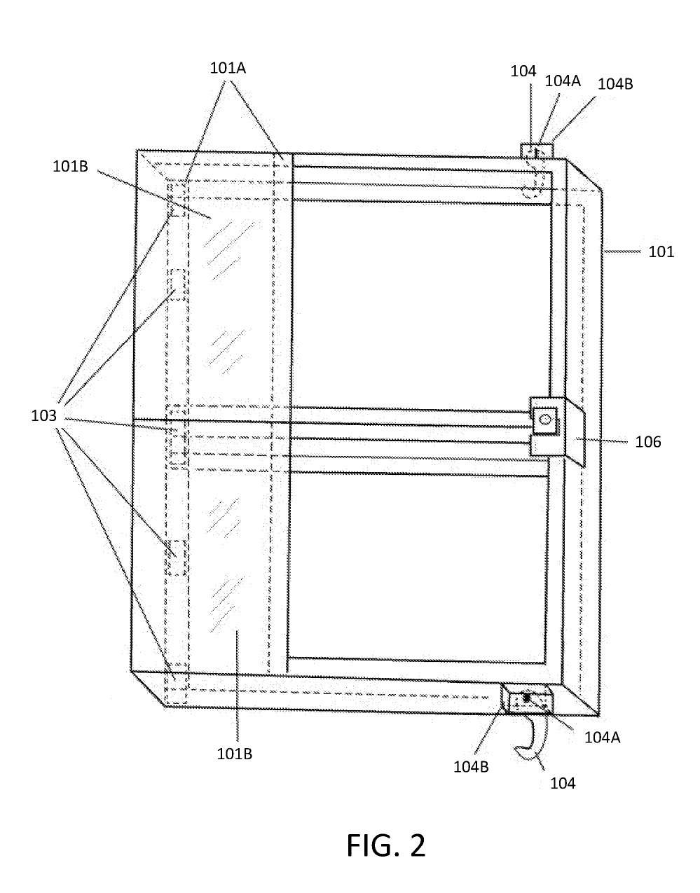

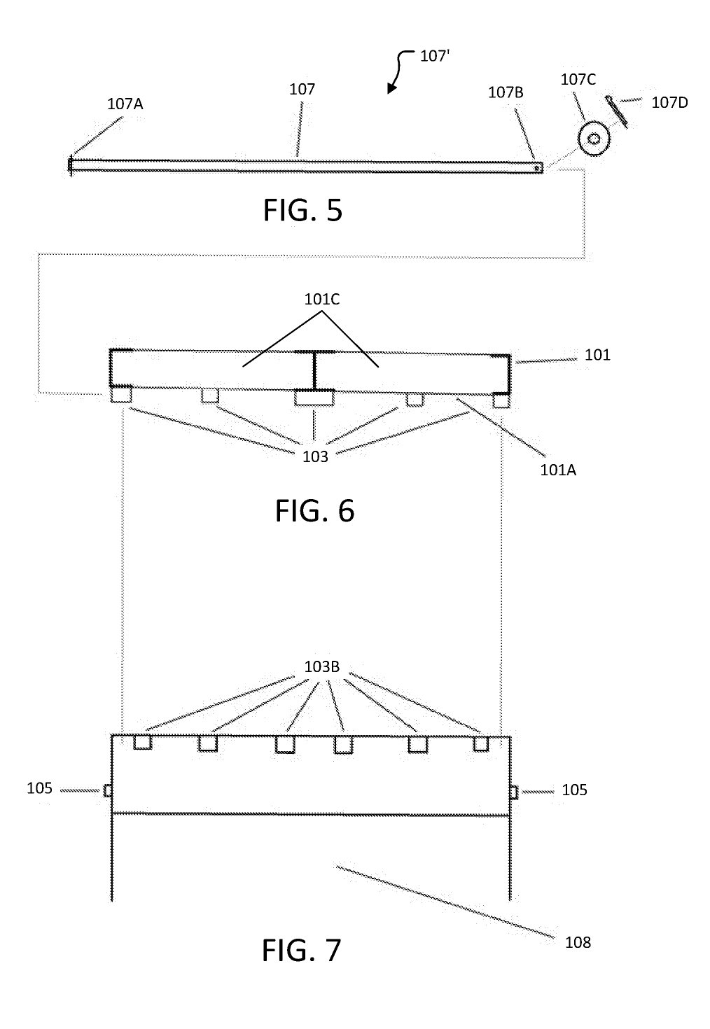

Referring to FIG. 2, a top perspective view of the frame 101 is illustrated. In one embodiment, the frame 101 can include a pair of channels 101C (shown in FIG. 6). The pair of channels 101C can be designed for the sliding doors 102, 102A to slide inside the channels 101C within the frame 101. A pair of plates 101A can be attached to frame 101. One of the plates 101A can be implemented to support the first cover sheet 101B on the top of the frame 101 and the other plate 101A can be attached to a bottom back end of the frame 101 for coupling the first set of knuckles 103 to the frame 101. In one embodiment, the knuckles 103 can be directly coupled to the plate 101A. The first cover sheet 101B can be attached to the frame 101 via the plate 101A on top of the frame 101.

In one embodiment, the gravity hook 104 can be rotatably coupled to the frame 101 by a pin 104A. The pin 104A can be coupled to the frame 101. The frame 101 can further include a pair of covers 104B that can be implemented to cover the gravity hooks 104 from inclement weather and environment. Typically, each of the gravity hooks 104 can include a cover 104B. For instance, one cover can be on the left side of the frame 101 and another one can be on the right side of the frame. Further shown in FIG. 2, the locking mechanism 106 can be located approximate a middle of the frame 101.

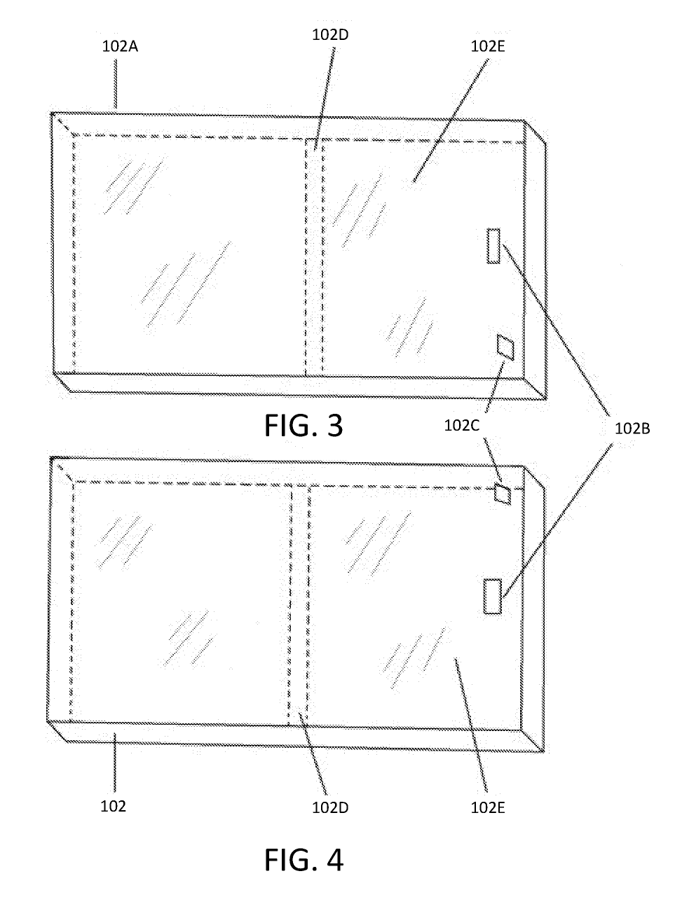

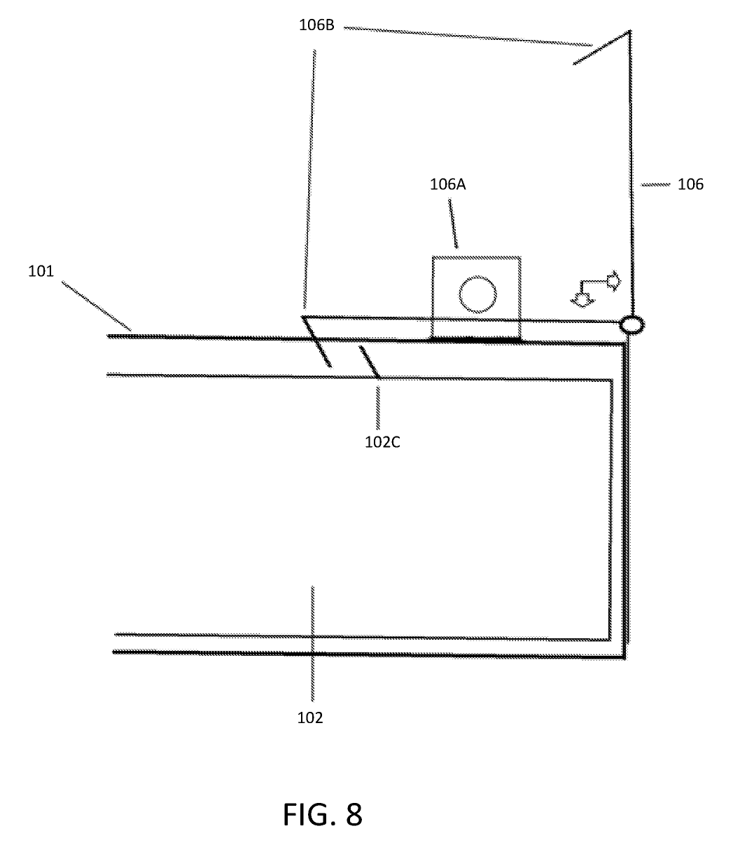

Referring to FIG. 3, a top perspective view of the second sliding door 102A is illustrated. As shown, the second sliding door 102A can include, but is not limited to, a handle 102B, a locking tab 102C, a support member 102D, and a sliding door cover sheet 102E. The sliding door cover sheet 102E can be attached to the second sliding door 102A and the support member 102D. Typically, the handle 102B can be attached to the sliding door cover sheet 102E proximate a bottom of the sliding door cover sheet 102E. The handle 102B can be implemented to allow a user to slide the second sliding door 102A up and down in the channels 101C of the frame 101. The handle 102B can further be implemented as a stop to keep the second sliding door 102A from sliding out of the frame 101. In one embodiment, the locking tab 102C can protrude out and be oriented at approximately a 45 degree angle in relation to the second sliding door 102A. The locking tab 102C can be positioned on a left lower bottom corner of the second sliding door 102A to interact with a tab 106B of the locking mechanism 106, as shown in FIG. 8.

Referring to FIG. 4, a top perspective view of the first sliding door 102 is illustrated. As shown, the first sliding door 102 can be substantially similar to the second sliding door 102A and can include each component of the second sliding door 102A. However, the locking tab 102C can be positioned in a right lower bottom corner of the first sliding door 102 to interact with the tab 106B of the locking mechanism 106.

Referring to FIG. 5, a back view of an attachment rod mechanism 107′ is illustrated. The attachment rod mechanism 107′ can be implemented to go through the first set of knuckles 103 attached to the frame 101 and the second set of knuckles 103A attached to the dumpster 108. As can be appreciated, the attachment rod mechanism 107′ can be implemented to couple the frame 101 to the dumpster 108. The attachment rod mechanism 107′ can include, but is not limited to, a rod 107, a first washer 107A, an aperture or hole 107B, a second washer 107C, and a cotter pin 107D. The first washer 107A can be attached to the rod 107 and implemented as a stop for an end of the rod 107. The hole 107B can be drilled into rod 107 for receiving the cotter pin 107D. The second washer 107C can be implemented as a stop for the other end of the rod 107. The cotter pin 107D can be implemented to keep the rod 107 coupled to the first set of knuckles 103 and the second set of knuckles 103A. As can be appreciated, the rod 107 can be passed through the first set and the second set of knuckles 103, 103A to create a hinged connection between the frame 101 and the dumpster 108. Of note, other means are contemplated for creating a rotatable connection between the frame 101 and the dumpster 108.

Referring to FIG. 6, a back view of the frame 101 is illustrated. As shown, one of the plates 101A can be located on a bottom of the frame 101. The first set of knuckles 103 can be attached to the plate 101A. As shown in FIG. 6, one example of a position and a number of knuckles are illustrated. Further, the channels 101C where the sliding doors 102, 102A can be inserted into the frame 101 is illustrated.

Referring to FIG. 7, a back view of the dumpster 108 is illustrated. As shown, the second set of knuckles 103A can be positioned to match with the first set of knuckles 103 on the frame 101. As can be appreciated, the rod 107 can be passed through the first set of knuckles 103 and the second set of knuckles 103A to rotatably couple the frame 101 to the dumpster 108. As can be appreciated, other means of rotatably coupling the frame 101 to the dumpster 108 are contemplated and the illustrated means is not meant to be limiting. The pair of receptacles 105 are also shown in FIG. 7, which are configured to interact with the gravity hooks 104.

Referring to FIG. 8, a side view of the locking mechanism 106 is illustrated. Typically, the locking mechanism 106 can include, but is not limited to, a locking tab 106A and a hinged tab 106B. A proximal end of the hinged tab 106B can be rotatably coupled to the frame 101. The hinged tab 106B can include a slot in a middle of the hinged tab 106B for the locking tab 106A to go through the hinged tab 106B when at an approximately 90 degree angle when closed. The locking tab 106A can be attached to the frame 101 and can include a hole for a lock or clip to pass through. A distal end of the hinged tab 106B can include protrusions oriented at an approximately 45 degree angle in relation to the hinged 106B to interact with the locking tabs 102C on the sliding doors 102, 102A. When the locking mechanism 106 is orientated at approximately 90 degrees, the locking mechanism 106 can lock the sliding doors 102, 102A in a closed position to prevent them from opening and providing access to the dumpster 108.

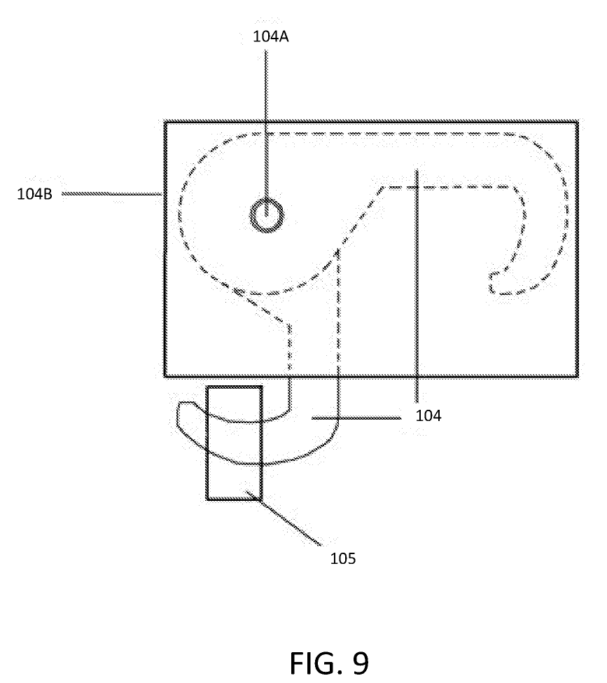

Referring to FIG. 9, a side view of one of the gravity hooks 104 is illustrated. As shown, the gravity hooks 104 can include the pin 104A to couple to the frame 101. The gravity hook 104 can be implemented to pivot on the pin 104A. As can be appreciated, when the dumpster 108 is on the ground, the gravity hook 104 will slide into the receptacle 105 preventing the frame 101 from being opened. The cover 104B can be implemented to provide protection from the environment and further to control how far the gravity hook 104 will pivot. The gravity hooks 104 can be implemented to lock the frame 101 down. When the dumpster 108 is tilted at approximately 45 degrees by a truck, for instance when the dumpster 108 is being emptied, the gravity hooks 104 will pivot on the pins 104A out of, and away from, the receptacles 105. When the gravity hooks 104 are free from the receptacles 105, the frame 101 can pivot on the rod 107, thus allowing the frame 101 to rotate from a closed position to an open position, to allow a commercial truck to empty the dumpster 108.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. An animal resistant dumpster comprising:
a refuse container, the refuse container including a first receptacle located on a right side of the refuse container and a second receptacle located on the left side of the refuse container; and
a lid rotatably coupled to the refuse container, the lid including:
a frame having at least one channel;
at least one door slidably engaged in the at least one channel of the frame;
a first hook rotatably coupled to a right side of the frame; and
a second hook rotatably coupled to a left side of the frame;
wherein (i) when the lid is closed, the first hook engages the first receptacle and the second hook engages the second receptacle; and (ii) when the refuse container is rotated approximately 45 degrees, the first hook is disengaged from the first receptacle and the second hook is disengaged from the second receptacle allowing the lid to rotate open.

2. The animal resistant dumpster of claim 1, wherein the first hook and the second hook are adapted to rotate due to gravity and disengage from respective receptacles.

3. The animal resistant dumpster of claim 1, wherein the frame includes a first door slidably engaged in a first channel and a second door slidably engaged in a second channel, the first door and the second door each slide from a closed position to an open position.

4. The animal resistant dumpster of claim 3, wherein the lid further includes a locking mechanism located proximate a middle bottom of the frame.

5. The animal resistant dumpster of claim 4, wherein the locking mechanism is adapted to lock the first door and the second door in the closed position.

6. The animal resistant dumpster of claim 4, wherein the locking mechanism includes a lever, the lever being rotatably coupled to the frame on a first end and having a pair of protrusions extending away from the lever at a second end.

7. The animal resistant dumpster of claim 6, wherein (i) the first door and the second door each include a protrusion extending out from the respective doors; and (ii) the pair of protrusions from the locking mechanism as adapted to interface with the first door protrusion and the second door protrusion.

8. The animal resistant dumpster of claim 6, wherein the locking mechanism further includes a tab having an aperture, the tab adapted to pass through a slit in the lever.

9. The animal resistant dumpster of claim 3, wherein a length of the first door and the second door is shorter than a length of the first channel and the second channel.

10. The animal resistant dumpster of claim 9, wherein the lid further includes a substantially rectangular plate.

11. The animal resistant dumpster of claim 10, wherein the plate is coupled proximate a top upper side of the frame.

12. The animal resistant dumpster of claim 10, wherein the first door and the second door are adapted to slide under the plate when in the open position.

13. The animal resistant dumpster of claim 1, wherein (i) the lid further includes a first set of knuckles; (ii) the refuse container includes a second set of knuckles; and (iii) a rod attachment mechanism mates the first set of knuckles to the second set of knuckles.

14. The animal resistant dumpster of claim 13, wherein the first set of knuckles, the second set of knuckles, and the rod attachment mechanism form a rotatable coupling between the lid and the refuse container.

15. A method of implementing an animal resistant dumpster, the method comprising:
providing an animal resistant dumpster, the animal resisting dumpster including:
a refuse container, the refuse container including a first receptacle located on a right side of the refuse container and a second receptacle located on the left side of the refuse container; and
a lid rotatably coupled to the refuse container, the lid including:
a frame having at least one channel;
at least one door slidably engaged in the at least one channel of the frame;
a first hook rotatably coupled to a right side of the frame; and
a second hook rotatably coupled to a left side of the frame;
restricting access to the refuse container by engaging the first hook with the first receptacle and engaging the second hook with the second receptacle;
emptying the refuse container by picking up and rotating the animal resistant dumpster approximately 45 degrees from parallel; and
wherein when the animal resistant dumpster is rotated approximately 45 degrees, the first hook rotates away from and disengages from the first receptacle and the second hook rotates away from and disengages from the second receptacle.

16. The method of claim 15, further including:
accessing the refuse container by sliding the first door or the second door open within the frame.

17. The method of claim 15, further including:
restricting access to the refuse container by locking the at least one door in a closed position.

18. The method of claim 15, wherein when the first hook is engaged with the first receptacle, the lid is restricted from rotating open.

19. The method of claim 15, wherein the lid is adapted to rotate open when the first hook and the second hook are each disengaged from respective receptacles.

20. A kit comprising:
a first receptacle adapted to be coupled to a right side of a refuse container;
a second receptacle adapted to be coupled to a left side of the refuse container;
a lid including:
a frame having at least one channel;
at least one door slidably engaged in the at least one channel of the frame;
a first hook rotatably coupled to a right side of the frame;
a second hook rotatably coupled to a left side of the frame; and
a first set of knuckles;
a second set of knuckles adapted to be coupled to the refuse container;
a rod assembly, wherein the rod assembly is adapted to mate the first set of knuckles with the second set of knuckles forming a rotatable coupling between the lid and the refuse container;
wherein when the lid is coupled to the refuse container and (i) is in a closed position, the first hook is adapted to engage the first receptacle and the second hook is adapted to engage the second receptacle; and (ii) when the refuse container is rotated approximately 45 degrees, the first hook is adapted to disengage from the first receptacle and the second hook is adapted to disengage from the second receptacle allowing the lid to rotate open.
